(19) United States
(12) Patent Application Publication
(10) Pub. No.: US 2018/0262016 A1
(43) Pub. Date: Sep. 13, 2018

(54) Optimizing Operability of Mobile Devices based on Learned Usage Models

(71) Applicant: International Business Machines Corporation, Armonk, NY (US)

(72) Inventors: Aaron K. Baughman, Silver Spring, MD (US); Gary F. Diamanti, Wake Forest, NC (US); Mauro Marzorati, Lutz, FL (US)

(21) Appl. No.: 15/455,290

(22) Filed: Mar. 10, 2017

(51) Int. Cl. H02J 7/00; G06N 3/04

(52) U.S. Cl. CPC H02J 7/007; G06N 3/0445

(57) ABSTRACT

A computer-implemented method, system and computer program product for managing remaining battery charge capacity in a battery-powered device having a power saving mode are provided. The computer-implemented method, system and computer program product ingest history data, the history data includes user application usage history data, user location history data, and battery charging history data for the device; forecast, based on real-time usage data, location data, battery charge data, and the ingested history data, a risk of running out of battery power; and adjust, in response to the forecasted risk, the device from a normal operating mode to a power saving mode to reduce battery consumption.

### BACKGROUND

### 1. Field

The present disclosure relates to computing devices, and more particularly, to a computer-implemented method, system and computer program product for managing a computing device to ensure the computing device's continued operability based on learned usage models.

### 2. Description of the Related Art

As we grow more and more dependent on portable devices (e.g., mobile devices such as laptop computers, smart devices, cellular phones, wearables and the like), it becomes more and more imperative that the devices remain available when needed. Thus, there is a need of ensuring the continued operability of these portable devices.

### SUMMARY

The present disclosure provides a computer-implemented method, system and computer program product for managing remaining battery charge capacity of a battery in a battery-powered device having a power saving mode. The computer-implemented method, system and computer program product ingest history data. The history data includes user application usage history data, user location history data, and battery charging history data for the device. The computer-implemented method, system and computer program then forecast, based on real-time usage data, location data, battery charge data, and the ingested history data, a risk of running out of battery power and adjust, in response to the forecasted risk, the device from a normal operating mode to a power saving mode to reduce battery consumption.

The present disclosure also provides a computer-implemented method that ingests history data. The history data includes application usage history data, critical activity history data, location history data, and battery charging history data for a computing device. The computer-implemented method then forecasts, based on real-time usage data, location data, battery charge data, and the ingested history data, a must-succeed moment of the computing device and modifies, in response to the forecasted must-succeed moment, present activity of the computing device.

### BRIEF DESCRIPTION OF THE DRAWINGS

FIG. 1 depicts a block diagram of a cell phone in accordance with an illustrative embodiment;

FIG. 2 depicts a block diagram of an exemplary recurrent neural network (RNN) system in accordance with an illustrative embodiment;

FIG. 3 depicts a flowchart of a process that may be used to configure a cognitive application to consume relevant data in accordance with an illustrative embodiment;

FIG. 4 depicts a flowchart of a process that may be used to make data available to the cognitive application in accordance with an illustrative embodiment;

FIG. 5 depicts a flowchart of a process that may be used to generate a risk assessment in accordance with an illustrative embodiment; and

FIG. 6 depicts a flowchart of a process that may be used to enable the cognitive application to autonomously take actions in accordance with an illustrative embodiment.

### DETAILED DESCRIPTION

The present disclosure provides a cognitive application for determining the most efficient way to use a device's available battery capacity based on a user's schedule and availability of charging options. To do so, the cognitive application keeps track of the usage pattern of the device, environments in which the device has been charged, locations where charging stations and/or docks are available, as well as impending critical activities in which the device may engage. This enables the cognitive application to accurately make a battery depletion risk assessment associated with allowing the device to engage in certain activities. For example, when, based on the current capacity of the device's battery, the location of the device relative to power, the user's habits and known schedule, there is a high risk of battery depletion before the device can be charged, then the cognitive application may not allow the device to engage in non-critical tasks in order to maximize battery capacity for the impending critical activities.

Further, the cognitive application of the present disclosure may determine a suitable time at which the device may engage in certain potentially disruptive activities. For example, there may be software updates, which may potentially be disruptive, that are scheduled to be installed onto the device. Suppose that based on the user's calendar, travel itineraries or current location etc., it appears that the user is or may soon be dependent on the device's continued operability, then the cognitive application may not apply the potentially disruptive updates. In such cases, the cognitive application may wait until such time when the user is no longer dependent on the device's continued operability to apply the updates, and in some cases may never apply the updates.

Generally, therefore, the cognitive application of the present disclosure may take actions on behalf of the user based on learned user behavior from prior scenarios, profile settings for how to optimize user preferences, the knowledge of whether or not the user may soon be using the device to perform a critical activity and the knowledge of whether or not power is available at a current location or will be available at a location the user is likely to be at a future time based on prior location data. The cognitive application may use a cognitive system such as a recurrent neural network (RNN) system to predict the device's next location based on user data. Using this location data, the cognitive application may produce a ranking for the user that corresponds to a risk level for the tasks, given the current location and current device requirements. Based on the risk level and the cognitive application's confidence level regarding a course of action, the cognitive application may autonomously take actions or make a recommendation to the user for controlling the mode or behavior of the device to ensure that critical requirements are able to be achieved based on the user's calendar and itinerary.

The present disclosure will be explained using a cellular (cell) phone, within which the cognitive application may be used. However, the disclosure is not thus restricted. Any device upon which there exist windows of time in which reliance is paramount is well within the scope of the present disclosure.

As an example, there are presently robotic assistants that are used to supplement human care takers in assisted living facilities. There may be times upon which a robotic assistant may be acting independently (i.e., without direct human supervision). During those periods of time, it is critical that the robotic assistant be fully functional. Hence, the cognitive application of the present disclosure may be used to ensure that the robotic assistant does not engage in non-critical activities before or during those times, lest the battery powering the robotic assistant is prematurely depleted rendering it inoperable. Furthermore, in addition to a power loss being a factor that could render the robotic assistant inoperable, a fatal software bug may do so as well. Hence, the cognitive application may in some instances not allow software updates until such time when the help of the robotic assistant is not needed and provided further that there is ample time to test the robotic assistant after such an update to ensure its continued operability.

As another example, wearable devices are oftentimes completely dependent on battery power. In such situations, their autonomy is directly related to the performance of the battery. Consequently, there are times when it may not be the best use of a wearable device, such as a pair of Google Glasses for instance, for the wearer to watch a streamed movie if it is critical for the device to remain functional for a long period of time. This is because streaming movies taxes the battery powering the device since streaming is an activity that constantly draws power for both audio and video outputs. Therefore, the cognitive application of the present disclosure may be used to block such activity from occurring before and during those times.

In yet another example, end-user equipments such as laptops, tablets, in-car infotainments and the like may be critically important at certain times. In addition to the low-power conditions described above, these devices may be more susceptible to unavailability due to programming errors. To avoid these situations, the cognitive application may not allow these devices to be used without having demos rehearsed and strict change control applied to avoid surprises.

In a further example, there are systems in which change freezes may be instituted at critical periods of time (i.e., quarter-end, year-end etc.). As these systems become more and more autonomous and apply code updates and changes independently, the cognitive application of the present disclosure may provide a mechanism to ascertain whether or not the application of a new code is advisable at a particular time. These systems may include systems of engagement (SOEs) and systems of record (SORs). An SOE is a decentralized information technology (IT) component that incorporates technologies, such as social media and the cloud, to encourage and enable peer interaction. By contrast, an SOR is an information storage and retrieval system that provides a centralized, authoritative source of data in an IT environment containing multiple points of data generation.

Generally, therefore, the cognitive application of the present disclosure may be used to enable computing systems to forecast, based on deep learning, their future must-succeed moments and to modify present activity accordingly. Thus, all computing systems may benefit from the cognitive application of the present disclosure. Consequently, the use of a cell phone to explain the rest of the disclosure is only for illustrative purposes.

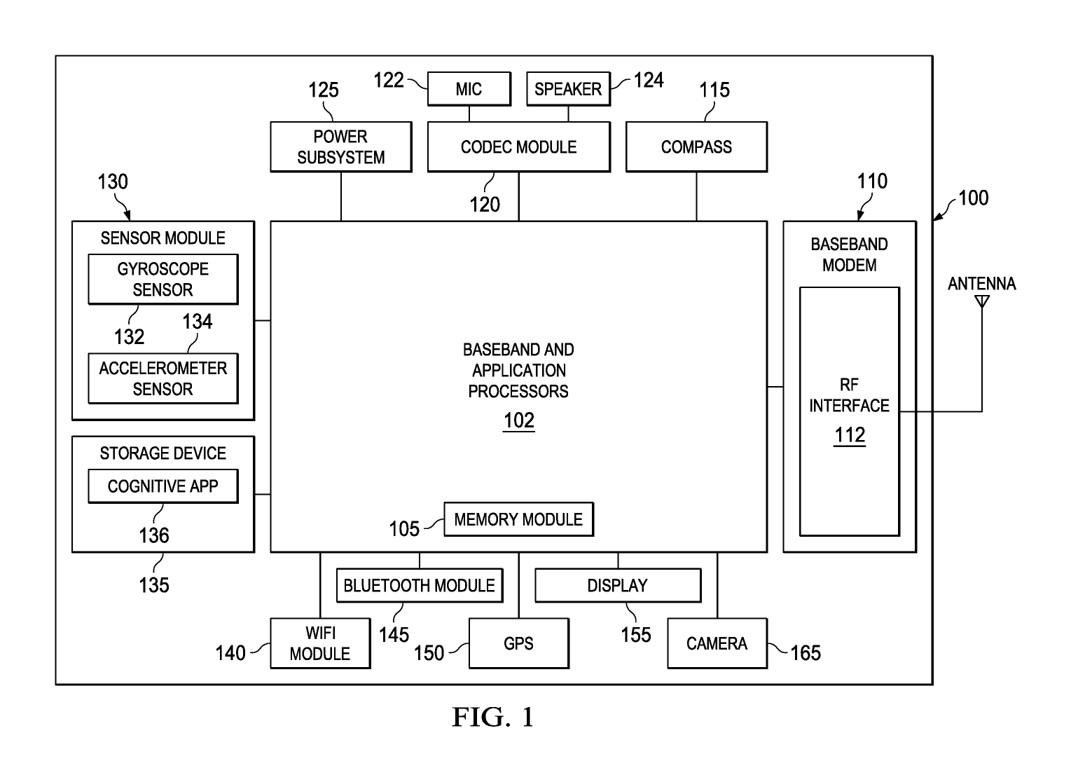

With reference now to the figures, FIG. 1 depicts a block diagram of a cell phone in accordance with an illustrative embodiment. The cell phone may be cell phone 100 shown in this figure. As shown, cell phone 100 includes baseband and application processors 102 having memory module 105 coupled thereto. Further coupled to baseband and application processors 102, is baseband modem 110 for sending and receiving voice communications. Baseband modem 110 includes radio frequency (RF) interface 112 that is connected to an antenna. Power subsystem 125 powers cell phone 100.

Cell phone 100 also includes compass 115 for detecting in which direction on a map cell phone 100 is facing, and Global Positioning System (GPS) receiver 150 for determining where on a map that may be displayed on display 155 cell phone 100 is located. Cell phone 100 may further include sensor module 130 which may include accelerometer sensor 134 and gyroscope sensor 132. Accelerometer sensor 134 may be used to measure acceleration in the three-dimensional coordinate system and gyroscope sensor 132 may be used to measure orientation changes or angular velocity. The two sensors may be used to determine whether cell phone 100 is tilted and in what direction, and other types of information about cell phone 100.

Cell phone 100 may further include camera 165 to capture photographs and record video clips and CODEC module 120 having integrated mic 122 and speaker 124. Cell phone 100 may use Wi-Fi module 140 for Wi-Fi communications and Bluetooth module 145 for Bluetooth communications.

In addition, cell phone 100 may include storage device 135 into which cognitive application 136 may be stored. According to the disclosure, cognitive application 136 may be configured to have access to key user documents, such as work and personal calendars, travel itineraries, email messages, and the like. Cognitive application 136 may also be configured to generate a charging profile of cell phone 100. To do so, cognitive application 136 may keep a record of each time cell phone 100 was charged and, with the help of GPS receiver 150, the location where cell phone 100 was when it was being charged. Thus, cognitive application 136 may possess key pieces of location data, such as private Wi-Fi networks (e.g., home and work networks) and trusted public networks (e.g., favorite restaurant, local pub, etc.).

Furthermore, cognitive application 136 may be configured to have access to a risk profile that a user may generate. In the risk profile, the user may indicate activities that the user may deem to be non-critical as well as those the user may consider to be of a critical or semi-critical nature. The user may further indicate preferences for the behavior of cell phone 100 when cognitive application 136 determines that a risk of battery depletion is imminent, for example. This indication may be on a scale of 1-3 for the varying degrees of function that may be locked out while the device is in a power saving mode or a lock down mode.

Cognitive application 136 may consume or ingest data that may allow cognitive application 136 to evaluate and learn the user's work and social patterns in respect to location data. Thus, cognitive application 136 may monitor planned location data, as well as actual location data, in order to accurately predict risks.

Cognitive application 136 may further use a feedback store to collect data regarding actions taken by the user to determine the accuracy of a forecast when a risk recommendation is provided. This may allow cognitive application 136 to enhance forecast accuracy and improve user experience in the future.

In sum, cognitive application 136 may ingest all sorts of data. For example, cognitive application 136 may know features, attributes, model, battery value, and version of the operating system (O/S) on cell phone 100. In another example, cognitive application 136 may also know that the last time the battery was at a 20% level, it took 37 minutes for the battery to be completely depleted. Cognitive application 136 may scour public forums and/or social networks to obtain information that may be used to make better predictions or risk assessments. For instance, cognitive application 136 may be aware, based on information on public forums or information published by the manufacturer of cell phone 100 that there are a lot of problems with a particular O/S update and that the update should not be applied or the update should be applied with care etc.

The more information that is available to cognitive application 136, the more accurate the predictions and risk assessments that may be made by cognitive application 136 as well as the more confident cognitive application 136 may be regarding the predictions and risk assessments. When cognitive application 136 is fairly confident about a prediction or a risk assessment, cognitive application 136 may take an action to mitigate the risk without consulting the user.

For example, suppose the user is at home and the user is scheduled to participate in a conference call. Cognitive application 136 will know that the user is at home through either the GPS location of cell phone 100 and/or cell phone 100 being connected to the user's home network and/or through other well known means. Cognitive application 136 will also know that the user is scheduled to participate in the conference call and that the user is not about to travel anytime soon etc. because cognitive application 136 consumes the user's calendar. Further, cognitive application 136 may be aware, based on the user's usage patterns, that the user generally uses the navigation application on cell phone 100 only when travelling. Thus, if there is an update to the navigation application, cognitive application 136 may apply the update without conferring with the user since cognitive application 136 is fairly confident that the user will not use the navigation application anytime soon. Hence, if the navigation software update were to change the manner with which the user may interact with the navigation application, for example, the user may have ample time to adjust to the new way of interacting with the navigation application before having to be dependent on the navigation application. After the update, cognitive application 136 may suggest that the user interact with the navigation application in order for the user to be familiar with any changes that the update may have introduced to the navigation application.

However, cognitive application 136 will not apply an O/S update to cell phone 100 before the conference call. This is because cognitive application 136 is aware that an O/S update may potentially be disruptive (e.g., may include software bugs that may lead to cell phone 100 malfunctioning) and thus jeopardizing the ability of the user to participate in the conference call.

Conversely, when cognitive application 136 is not too confident about a course of action, cognitive application 136 may confer with the user before taking the action or recommend an action to the user. For example, suppose the user is on his/her way to an intercontinental flight. Again, cognitive application 136 will know so since cognitive application 136 consumes or ingests the user's calendar and email messages that may contain the user's travel itinerary as well as other relevant information. Armed with such knowledge and other critical pieces of data (i.e., battery capacity level, flight time etc.), cognitive application 136 may produce a battery depletion risk assessment. However, since cognitive application 136 is not sure as to whether or not there will be power available at a location during the user's itinerary, whether or not the environment at the location is conducive to charging cell phone 100, whether or not the user may have time to charge cell phone 100 etc., cognitive application 136 may recommend a course of action to the user based on the risk assessment instead of autonomously taking the action.

The recommendation may be to not engage in non-critical activities while in transit. Thus, if the user had indicated in the risk profile that software updates are non-critical activities, the recommendation from cognitive application 136 may be to not perform O/S updates and/or application updates and/or firmware updates during the itinerary to ensure that the device does not run out of power before reaching the user's destination. Likewise, if posting onto social networks such as Facebook, Twitter, Instagram and the like is considered to be a non-critical activity, such activity may be discouraged as well to ensure that the device conserves energy.

Specifically, cognitive application 136 may be used to inform the user, when the user is away from power, or when the user is away from conventional support structures (i.e., the user is travelling and thus is totally dependent on cell phone 100), that cell phone 100 is to be in lock down mode 1 or lock down mode 2. Lock down mode 1 may inform the user that it is imperative that battery power be conserved lest the battery is depleted before performing or during the performance of a planned (critical) activity. Whereas, lock down mode 2 may indicate that power saving is not necessary since there are not any critical activities planned. Thus, based on all available data, cognitive application 136 may provide a risk forecast for the mode the device should be running in based on the device state, current power or battery availability, current and predicted location, usage requirements, and user pattern data.

Note that if cognitive application 136 were to be confident that there would not be any opportunity for the user to charge cell phone 100 before destination, cognitive application 136 may automatically put the device into the recommended mode without conferring with the user. In any event, if the user were to charge the device along the way and/or if one of the user's requirements were to no longer be applicable and/or if the user were to decide to enable a non-recommended mode etc., cognitive application 136 may perform another battery depletion risk assessment and generate another recommendation based on the new assessment.

If a prediction returns a high risk of battery depletion, then there is a deficit condition and an alternate source of power may be needed to charge cell phone 100. This is because the battery in power subsystem 125 powering cell phone 100 is likely to be depleted before the user may have a chance to charge cell phone 100 through conventional means. Using deep learning with semi-supervised techniques, cognitive application 136 may determine the availability of an alternate power source such as solar, wind, water and other suitable types of power sources. Based on the availability of an acceptable alternate power source, cell phone 100 may be adapted or transformed to consume this source of power in such an emergency situation.

In any event, cognitive application 136 may use a data normalization function to generate a normalized time based location matrix of the user's planned destinations from all ingested data including configured document sources, real time GPS location data etc. As mentioned above, cognitive application 136 may use an RNN to predict the next location of the device. The output from the normalization function may be fed into the RNN to facilitate such prediction. Thus, the RNN may generally be trained with the location matrix data for better device location inference and/or prediction. The RNN may also be trained with other data to predict the next state of cell phone 100.

RNNs are generally networks of neurons or cells with feedback connections. RNNs can learn many behaviors, sequence process tasks, algorithms, programs that are not learnable by traditional machine learning methods. The sequence processing is relegated to the neurons that do very simplistic operations. The interconnections between the neurons give the RNN intelligence. In the present case, the RNN may use multiple types of user data for creating the location prediction and for subsequently helping with the risk ranking for the mode in which the device should be run to ensure its continued operability.

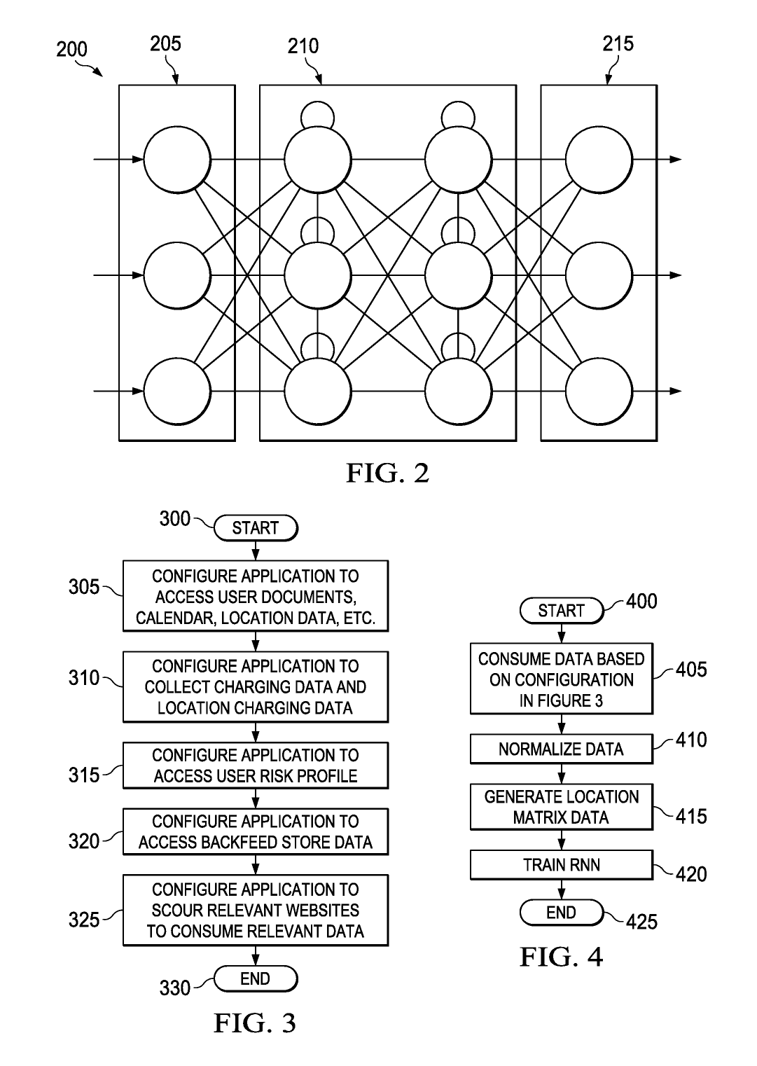

FIG. 2 depicts a block diagram of an exemplary RNN system. The RNN system may be RNN system 200 shown in the figure. RNN system 200 includes 1×N input matrix 205 of neurons or cells, N×N matrix 210 of recurrent neurons or cells and 1×N output matrix 215 of neurons or cells which are interconnected, N being an integer. As can be seen from the figure, each recurrent cell or neuron in N×N matrix 210 has a plurality of inputs and outputs as well as a feedback input.

The feedback input from a recurrent neuron or cell in N×N matrix 210 is used as an output from a previous run and input in a successive run (hence the “recurrent” nomenclature). By taking a window representing a sequence of location data where the user has been based on predicted (i.e., calendar data) and actual locations and training the RNN to predict a window that is slightly temporally shifted, the model can output the most probable next location where the device may be.

Further, the RNN may predict whether there may be alternate power sources at certain locations. In the example in the figure, each output cell is a modality for cell phone 100, shown in FIG. 1. For example, given an input of weather, location and movement, the modalities of solar, kinetic energy or plug-in power source can be output with a positive or negative probability. If both solar and kinetic energy are positive, cell phone 100 may have multiple modes (i.e., solar and kinetic or wind) from which to draw energy.

Note that although three types of cells are shown in the exemplary RNN system 200 of FIG. 2, the invention is not thus restricted. For example, the exemplary RNN system 200 may include back-fed input cells, noisy input cells, hidden cells, probabilistic hidden cells, spiking hidden cells, match input output cells, memory cells, different memory cells, kernel cells, and convolution or pool cells etc. Thus, the use of the three types of cells are for illustrative purposes only.

FIG. 3 depicts a flowchart of a process that may be used to configure a cognitive application to consume relevant data in accordance with an illustrative embodiment. The cognitive application may be cognitive application 136 of FIG. 1. The process starts at block 300 when a user decides to configure cognitive application 136 of FIG. 1 running on the device (e.g., cell phone 100) to consume data that may be used to generate a risk assessment of whether it is likely that the device may run out of power before there is a chance of charging or re-charging the device. To do so, the user may have to configure cognitive application 136 to access pertinent user documents, calendar, e-mail messages, location data etc. to consume relevant data stored therein (block 305). The user may also configure cognitive application 136 to collect charging data (i.e., whether the device has been fully charged, time the device was plugged-in as opposed to calendar appointments etc.) as well as locations where the device has been charged etc. (block 310). The charging data may help in forecasting whether a location or a next location includes power sources from which to charge the device.

As mentioned earlier, the user may have to generate a risk profile into which the user may indicate activities that are critical, semi-critical, non-critical etc. This may be done by assigning a numerical value of 1-3 to the activities, where one represents the most critical and three the least critical of the activities or vice versa. The user may configure the cognitive application 136 to access this risk profile to consume the relevant data stored therein (block 315).

Further, the user may also configure cognitive application 136 to access a backfeed store in order to consume data stored therein (block 320). The backfeed store is where all actions taken by the user are registered and all prediction assessments are stored (whether the assessments are correct or not). For example, if cognitive application 136 makes a mode recommendation to the user based on a risk assessment, the system will take notice of the choice made by the user (i.e., whether or not the user followed the recommendation and what had happened if the user did not follow the recommendation) and store data representing the action taken by the user into the backfeed store. As another example, if RNN system 200 of FIG. 2 makes a next location prediction, the system will take notice as to whether the user actually did go to that predicted next location and store the data representing whether or not the prediction was correct into the backfeed store. If, further, the system predicted that there would be power available at that next location, the system will store into the backfeed store data representing whether or not the prediction was correct. Data representing whether or not the user did charge the device while at the predicted location will also be stored at the backfeed store. This allows cognitive application 136 of FIG. 1 to make better risk assessments and RNN 200 of FIG. 2 to make better next location predictions in the future.

In addition, the user may configure cognitive application 136 to scour relevant web sites such as social network sites, manufacturer's web sites, product review web sites etc. to consume relevant data therein (block 325). The process ends after the user has configured cognitive application 136 to consume all data necessary to make the proper predictions and risk assessments (block 330).

FIG. 4 depicts a flowchart of a process that may be used to make data available to a cognitive application and an RNN system in accordance with an illustrative embodiment. The cognitive application may be cognitive application 136 of FIG. 1. The RNN system may be RNN system 200 of FIG. 2. The process starts at block 400 when a user activates cognitive application 136 to consume or ingest data as was configured in FIG. 3 (block 405). Once activated, cognitive application 136 will continually consume or ingest all relevant data that it has been configured to consume. Each time data is consumed or ingested, the data is normalized (block 410) to generate a location matrix and next state matrix data (block 415) that may be used to train RNN system 200 of FIG. 2 (block 420). The process ends when the device is turned off (block 425) and resumes when the device is turned back on.

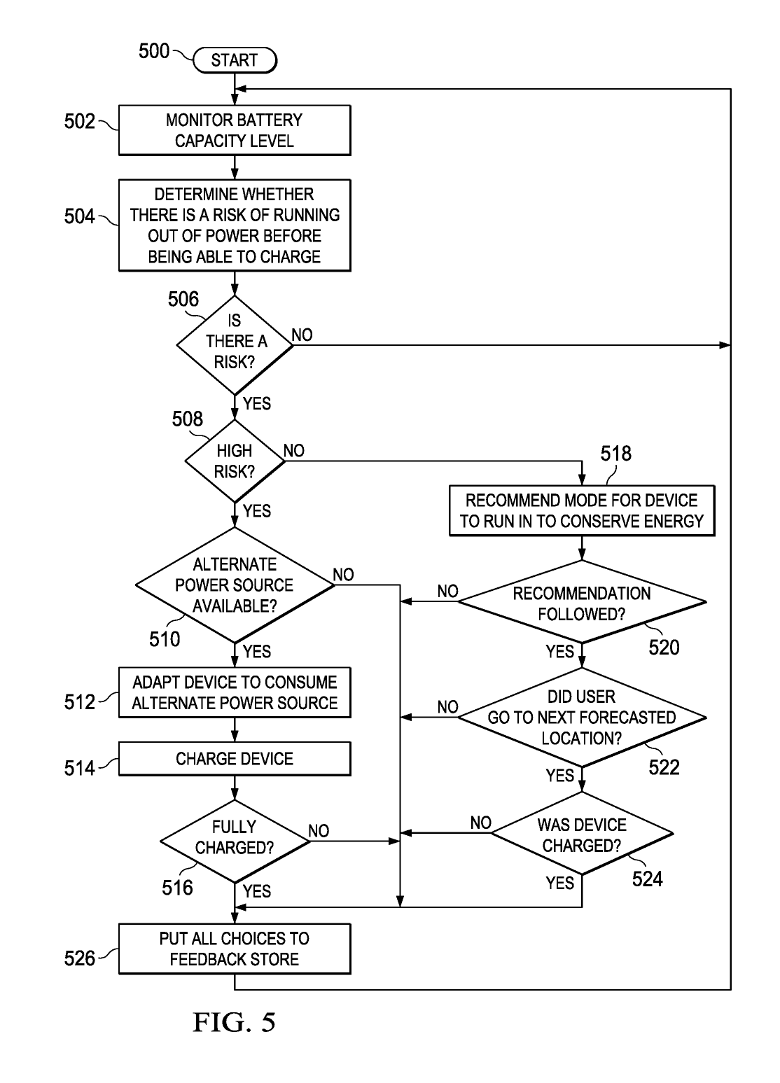

FIG. 5 depicts a flowchart of a process that may be used to generate a risk assessment in accordance with an illustrative embodiment. The process starts at block 500 after cognitive application 136 of FIG. 1 has been activated to consume data as configured in FIG. 3. Upon starting, the process monitors the battery capacity level of the device (block 502) and determines whether there is a risk of running out of power before the device is able to be charged (blocks 504 and 506). As mentioned earlier, this risk is based on the current capacity level of the device's battery, the location of the device relative to power, the user's habits and known schedule, critical activities that need to be performed and other information from the device. If there is not a risk of running out of power, the process goes back to block 502 to continue monitoring the battery capacity level.

If there is a risk of running out of power, then it is determined whether such risk is high (block 508). Again, as mentioned above, a high risk of battery depletion occurs when there is a deficit condition whereby, whether or not the user follows the recommended usage mode, cell phone 100 of FIG. 1 is likely to run out of power. This situation usually occurs when there are not conventional power sources available and alternate power sources may have to be sought. Thus, the process, with the help of RNN system 200 of FIG. 2, may determine whether there is an alternate power source available (block 510). If there is not an alternate power source available, the process goes on to block 526 where such a situation (i.e., last time device was charged, activities that the device was engaged in to allow such a situation to occur, the locations where the device has been, whether there was available power sources at those locations, whether there was any time to charge the device if the location includes power sources etc.) is entered into feedback store. This will allow cognitive application 136 to make better recommendations (e.g., whether the device should be charged at prior locations if those locations include power sources in cases where there is a likelihood that the device may be in a location devoid of power sources etc.) and for RNN 200 to make better predictions in the future.

If there is an alternate power source available, the user may be prompted to adapt the device to consume power from the alternate power source such that the device may be able to be charged using the alternate power source (block 512). If the device is adapted to consume the alternate power source, the device may be charged (block 514). The process will make a note as to whether the device was fully charged or not (block 516) before the process goes to block 526 where such a situation (i.e., the type of alternate power source that was available, whether or not the device was charged fully or otherwise etc.) is entered into feedback store. Following the completion of block 526, the process returns to block 502.

Returning to block 508, if there is not a high risk of running out of power, then cognitive application 136 makes a recommendation of the mode in which the device should run in order to conserve energy (block 518). For example, cognitive application 136 may recommend blocking all non-critical activities (e.g., lock down mode 1), as indicated in the risk profile, from being performed until such time the device has been charged. Note that the severity of the risk may determine whether semi-critical activities should be blocked along with the non-critical activities. The process then determines whether the user has followed the recommendation (block 520). If not, the process goes to block 526 where the process enters the user's action (e.g., failure to follow the recommendation) into the feedback store. If the user follows the recommendation, the process then determines whether the user did go to the next forecasted location (block 522) and if so, whether the device was charged at that location (block 524) in the case where the location is known to have power sources available to charge the device. As can be seen from the figure, whether or not the recommendation was followed or the user did go to the next forecasted location or the device was charged at that location will all be noted and stored into the feedback store (block 526). After entering all choices made by the user into the feedback store the process returns to block 502 to continue monitoring the level of the battery capacity. The process ends when the device is turned off and resumes when the device is turned back on.

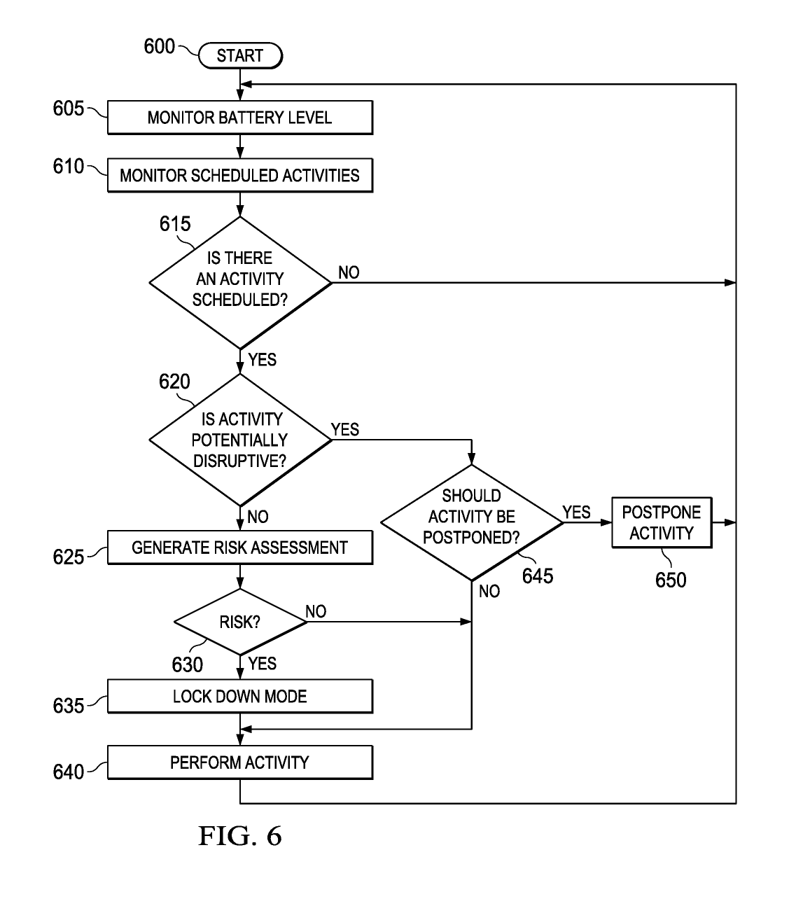

FIG. 6 depicts a flowchart of a process that may be used to enable a cognitive application to autonomously take actions in accordance with an illustrative embodiment. The cognitive application may be cognitive application 136 of FIG. 1. The process starts at block 600 after cognitive application 136 of FIG. 1 has been activated to consume data as configured in FIG. 3. Upon starting, the process monitors the battery capacity level of the device (block 605) and monitor scheduled activities (block 610) to determine whether there are scheduled activities (block 615) in the near future. If there is not a scheduled activity, the process returns to block 605. If there is a scheduled activity, it is determined whether or not the activity is potentially disruptive (block 620). As mentioned earlier, software updates are usually potentially disruptive. By contrast, a conference call or a presentation is not a potentially disruptive activity.

If the scheduled activity is not potentially disruptive, the process generates a battery risk assessment (block 625) to determine whether there is a risk (block 630) of running out of power before or during the activity. If there is such a risk, the process may put the device into a lock down mode (e.g., lock down mode 1) to ascertain that there will be power available to perform the task at the scheduled time before the process returns to block 605 (blocks 635 and 640). If no such risk exists, the process may just perform the activity at the scheduled time (block 635) before returning to block 605 (e.g., the device may be put in lock down mode 2).

If the scheduled activity at block 620 is a potentially disruptive activity, then it may be determined whether the activity should be postponed (block 645). The activity should be postponed if there is a critical activity that may soon follow the scheduled performance of the disruptive activity. For instance, if the user is to soon be out of town where the user may be totally dependent on the device without other support structure, the potentially disruptive activity should be postponed. Further, if there is soon to be a conference call or a presentation and the like for which the user may have to use the device, then the potentially disruptive activity should be postponed. If the disruptive activity should be postponed, then the process postpones the activity (block 650) until after the performance of the critical activity and the process returns to block 605. If the scheduled potentially disruptive activity should not be postponed (i.e., there is not a critical activity that is soon to follow the performance of the potentially disruptive activity), then the process performs the activity (block 640) before the process returns to block 605.

The present invention may be a system, a method, and/or a computer program product at any possible technical detail level of integration. The computer program product may include a computer-readable storage medium or media having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing devices. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing devices. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function or act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions or acts specified in the flowchart and/or block diagram block or blocks.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, a segment, or a portion of instructions, which comprises one or more executable instructions for implementing the specified logical function or functions. In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method of managing remaining battery charge capacity of a battery in a battery-powered device having a power saving mode, the method comprising:
ingesting history data, the history data including user application usage history data, user location history data, and battery charging history data for the device;
forecasting, based on real-time usage data, location data, battery charge data, and the ingested history data, a risk of running out of battery power; and
adjusting, in response to the forecasted risk, the device from a normal operating mode to a power saving mode to reduce battery consumption.

2. The computer-implemented method of claim 1, wherein the power saving mode includes at least one application lockout mode based on user usage history.

3. The computer-implemented method of claim 1, wherein the power saving mode includes at least one application lockout mode based on stated user preferences.

4. The computer-implemented method of claim 1, wherein a recurrent neural network (RNN) is used to forecast the risk based on predicting usage of the device between a current time and a predicted time when the battery may be recharged.

5. The computer-implemented method of claim 4, wherein the predicted time is based on a predicted location of the device.

6. A computing system for managing remaining battery charge capacity of a battery in a battery-powered device having a power saving mode, the computing system comprising:
at least one storage system for storing code data; and
at least one processor for processing the stored code data to:
ingest history data, the history data including user application usage history data, user location history data, and battery charging history data for the device;
forecast, based on real-time usage data, location data, battery charge data, and the ingested history data, a risk of running out of battery power; and
adjust, in response to the forecasted risk, the device from a normal operating mode to a power saving mode to reduce battery consumption.

7. The computing system of claim 6, wherein the power saving mode includes at least one application lockout mode based on user usage history.

8. The computing system of claim 6, wherein the power saving mode includes at least one application lockout mode based on stated user preferences.

9. The computing system claim 6, wherein a recurrent neural network (RNN) is used to forecast the risk based on predicting usage of the device between a current time and a predicted time when the battery may be recharged.

10. The computing system claim 9, wherein the predicted time is based on a predicted location of the device.

11. A computer program product for managing remaining battery charge capacity of a battery in a battery-powered device having a power saving mode, the computer program product comprising a computer-readable storage medium having program instructions embodied therewith, the instructions executable by a processor to cause the processor to:
ingest history data, the history data including user application usage history data, user location history data, and battery charging history data for the device;
forecast, based on real-time usage data, location data, battery charge data, and the ingested history data, a risk of running out of battery power; and
adjust, in response to the forecasted risk, the device from a normal operating mode to a power saving mode to reduce battery consumption.

12. The computer program product of claim 11, wherein the power saving mode includes at least one application lockout mode based on user usage history.

13. The computer program product of claim 11, wherein the power saving mode includes at least one application lockout mode based on stated user preferences.

14. The computer program product claim 11, wherein a recurrent neural network (RNN) is used to forecast the risk based on predicting usage of the device between a current time and a predicted time when the battery may be recharged.

15. The computer program product of claim 14, wherein the predicted time is based on a predicted location of the device.

16. A computer-implemented method comprising:
ingesting history data, the history data including application usage history data, critical activity history data, location history data, and battery charging history data for a computing device;
forecasting, based on real-time usage data, location data, battery charge data, and the ingested history data, a must-succeed moment of the computing device; and
modifying, in response to the forecasted must-succeed moment, present activity of the computing device.

17. The computer-implemented method of claim 16, wherein modifying the present activity of the computing device includes blocking the device from performing potentially disruptive activities.

18. The computer-implemented method of claim 16, wherein modifying the present activity of the computing device includes blocking the device from performing non-critical activities.

19. The computer-implemented method of claim 16, wherein the potentially disruptive activities include software updates.

20. The computer-implemented method of claim 19, wherein the potentially disruptive activities are blocked to ensure that software bugs are not introduced into the computing device before the forecasted must-succeed moment.
